(19) United States
(12) Patent Application Publication
(10) Pub. No.: US 2018/0374382 A1
(43) Pub. Date: Dec. 27, 2018

(54) FLY FISHING TRAINING AID

(71) Applicant: Paul Dennis Osimo, Providence, RI (US)

(72) Inventor: Paul Dennis Osimo, Providence, RI (US)

(21) Appl. No.: 16/001,192

(22) Filed: Jun. 6, 2018

Related U.S. Application Data
(60) Provisional application No. 62/522,939, filed on Jun. 21, 2017.

(51) Int. Cl. G09B 19/00

(52) U.S. Cl. CPC G09B 19/0038; A01K 91/12

(57) ABSTRACT

A fly fishing training aid including a base and a connector. The base includes a spool having a cylinder shape. The base further includes a first sidewall joined to and extending from a first side edge of the spool and a second sidewall joined to and extending from a second side edge of the spool. A looped channel is defined in between the first sidewall, the spool and the second sidewall. The first sidewall, the spool, and the second sidewall are fixed together. The connector is joined to and extends from the base. The connector is configured to secure the base to a fishing pole.

### CROSS-REFERENCE TO RELATED APPLICATION

This application claims the benefit of priority of U.S. provisional application No. 62/522,939, filed Jun. 21, 2017, the contents of which are herein incorporated by reference.

### BACKGROUND OF THE INVENTION

The present invention relates to fly fishing and, more particularly, to a fly fishing training aid.

Fly fishing is an angling method in which an artificial fly is used to catch fish. The fly is cast using a fly rod, reel, and specialized weighted line. Casting a nearly weightless fly or lure requires casting techniques significantly different from other forms of casting. Fly fishermen use hand tied flies that resemble natural invertebrates, baitfish, other food organisms, or lures to provoke the fish to strike (bite at the fly).

Practice fly casting rods currently do not provide the option of a usable fishable line for light fishing use and for allowing the user to properly practice casting with the equipment used in real fishing situations. Further, practice fly casting rods do not include the line capacity to effectively practice advanced fly casting techniques such as the Double Haul, and to use this additional line to properly play and land fish.

As can be seen, there is a need for an improved fly fishing training aid that allows the user to practice fly fishing and to perform fly fishing.

### SUMMARY OF THE INVENTION

In one aspect of the present invention, a fly fishing training aid comprises: a base comprising a spool comprising a cylinder shape, a first sidewall joined to and extending from a first side edge of the spool, and a second sidewall joined to and extending from a second side edge of the spool, wherein a looped channel is defined in between the first sidewall, the spool, and the second sidewall, wherein the first sidewall, the spool, and the second sidewall are fixed together; and a connector joined to and extending from the base, wherein the connector is configured to secure the base to a fishing pole.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a front view of an embodiment of the present invention;

FIG. 4 is a perspective view of an embodiment of the present invention;

FIG. 5 is a front view of an embodiment of the present invention;

FIG. 6 is an exploded view of an embodiment of the present invention, illustrating an attachment to a fishing rod;

FIG. 7 is a cross-section view taken along line 7-7 from FIG. 4;

FIG. 8 is a perspective view of an embodiment of the present invention;

FIG. 9 is a front view of an embodiment of the present invention;

FIG. 10 is a perspective view of an embodiment of the present invention;

FIG. 11 is a front view of an embodiment of the present invention;

FIG. 12 is a front exploded view of an embodiment of the present invention; and

FIG. 13 is a rear exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fixed fishing line spool that can attach to a standard or proprietary fishing rod. The present invention may be used for light fishing applications and/or for advanced fly casting practice. This fixed action spool provides the user with a skill honing device that uses real fly line with the addition of an offset counterbalance or action spool that accurately mimics the action and feel of a full-sized fly fishing setup. Because the offset counterbalance or action spool is designed to hold additional line, the present invention can be successfully used in real fishing and advanced fly casting practice situations.

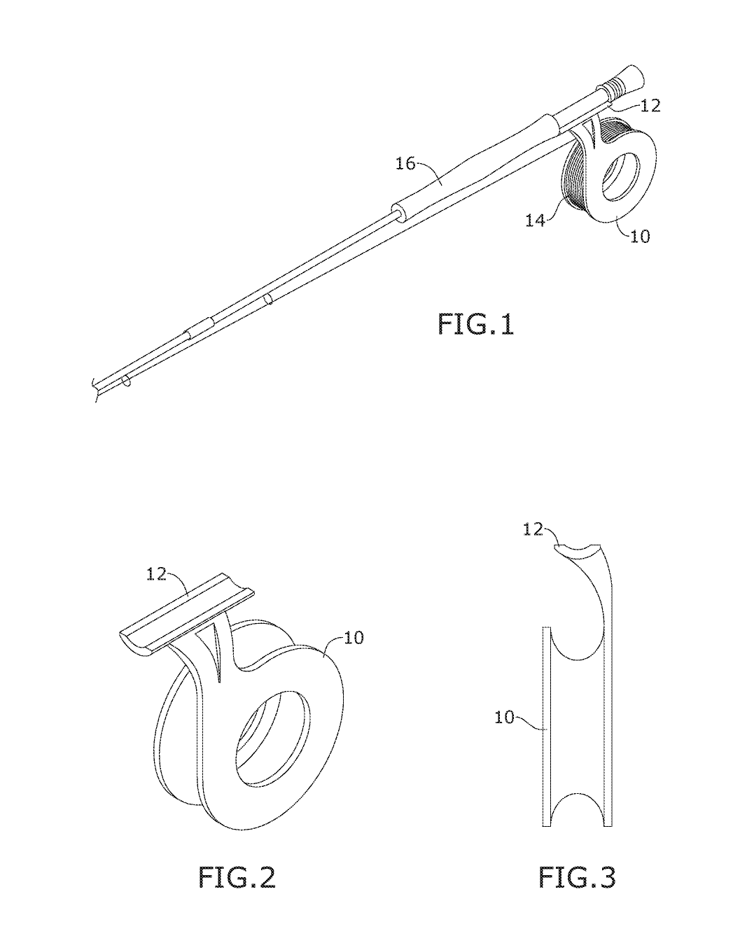

Referring to FIGS. 1 through 3, the present invention includes a fly fishing training aid including a base 10 and a connector 12. The base 10 includes a spool having a cylinder shape. The base 10 further includes a first sidewall joined to and extending from a first side edge of the spool and a second sidewall joined to and extending from a second side edge of the spool. A looped channel is defined in between the first sidewall, the spool and the second sidewall. The first sidewall, the spool, and the second sidewall are fixed together. In some embodiments, the base 10 is integral. The connector 12 is joined to and extends from the base 10. The connector 12 is configured to secure the base 10 to a fishing pole 16. The connector 12 may include an attachment foot or a butt cap attachment, which is described in more detail below.

A fishing line 14 is wrapped around the spool. As mentioned above, the base 10 includes a looped channel. In certain embodiments, the cross-section of the looped channel has a U-shape. In such embodiments, the looped channel is rounded, allowing the user to smoothly practice casting the fishing line 14. In certain embodiments, the connector 12 includes an attachment foot. The attachment foot 12 is extending from one of the first sidewall and the second sidewall. The attachment foot is an elongated half pipe shape that secures to the fishing pole 16.

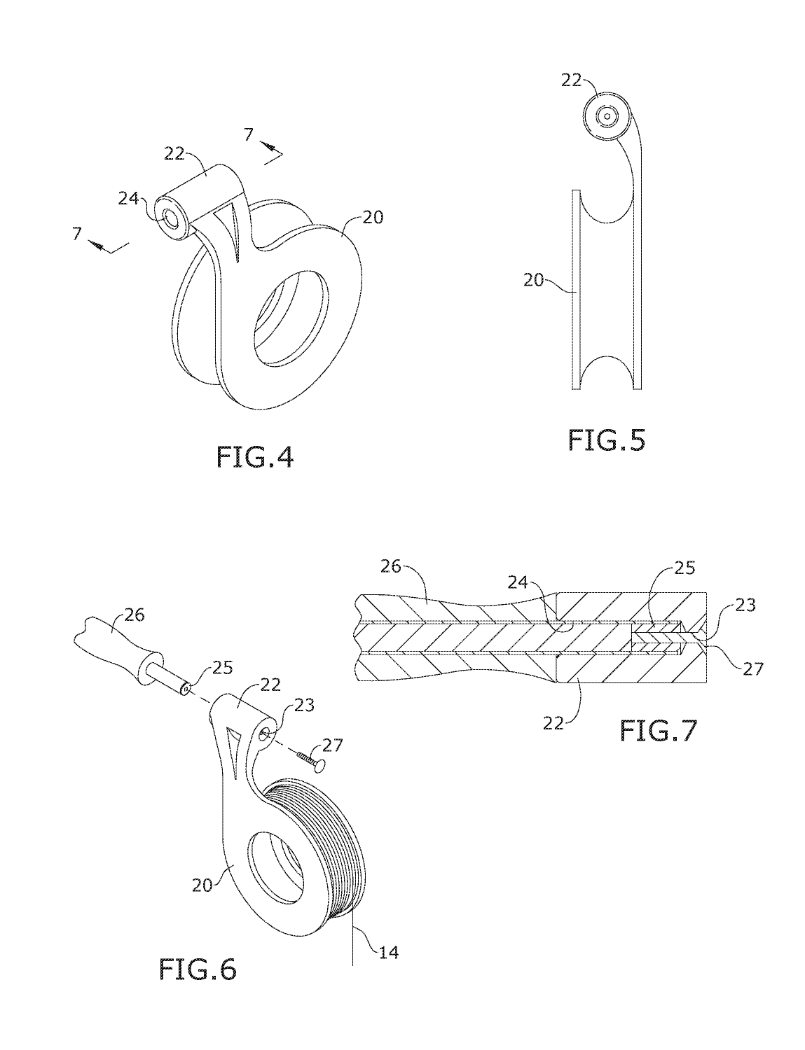

Referring to FIGS. 4 through 7, a fly fishing training aid includes a base 20 and a connector 22. The base 20 includes a spool having a cylinder shape. The base 20 further includes a first sidewall joined to and extending from a first side edge of the spool and a second sidewall joined to and extending from a second side edge of the spool. A looped channel is defined in between the first sidewall, the spool and the second sidewall. The first sidewall, the spool, and the second sidewall are fixed together. In some embodiments, the base 20 is integral. The connector 22 is joined to and extends from the base 10. The connector 22 is configured to secure the base 20 to a fishing pole 26. The connector 22 includes a butt cap attachment. The butt cap attachment is a tube having an first end 24 including an opening to receive an insert 25 of a fishing pole 26 and a second end 23 including a countersunk opening to receive a screw 27. The insert 25 is placed into the butt cap through the opening of the first end 24, and the screw 27 runs through the countersunk opening of the second end 23 and mechanically fastens within a threaded opening of the insert 25.

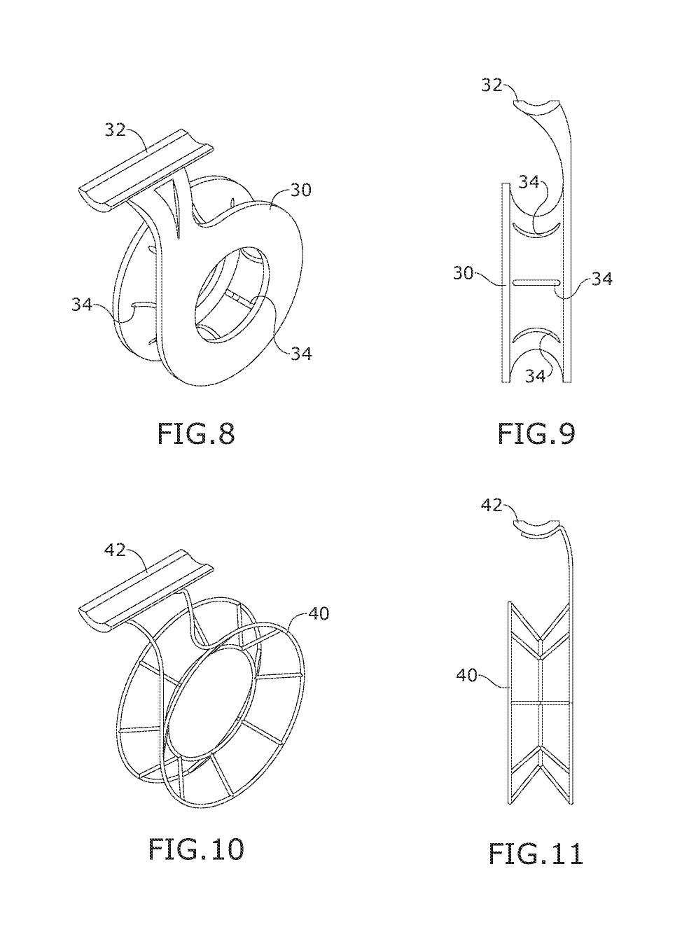

Referring to FIGS. 7 and 8, a fly fishing training aid includes a base 30 and a connector 32. The base 30 includes a spool having a cylinder shape. The base 30 further includes a first sidewall joined to and extending from a first side edge of the spool and a second sidewall joined to and extending from a second side edge of the spool. A looped channel is defined in between the first sidewall, the spool and the second sidewall. The first sidewall, the spool, and the second sidewall are fixed together. In some embodiments, the base 30 is integral. The base 30 further includes a plurality of slots 34 each running from the first sidewall, across the spool and to the second sidewall. The plurality of slots 34 are spaced apart circumferentially about the base 30. The slots 34 allow the fishing line to dry out. The connector 32 is joined to and extends from the base 30.

Referring to FIGS. 9 and 10, a fly fishing training aid includes a base 40 and a connector 42. The base 40 includes a spool having a circular shape. The base 40 further includes a first sidewall joined to and extending from a first side edge of the spool and a second sidewall joined to and extending from a second side edge of the spool. A looped channel is defined in between the first sidewall, the spool and the second sidewall. The first sidewall, the spool, and the second sidewall are fixed together. The base 40 is formed of a plurality of adjoined wires. In such embodiments, the cross section of the looped channel has a V-shape. The connector 42 is joined to and extends from the base 40.

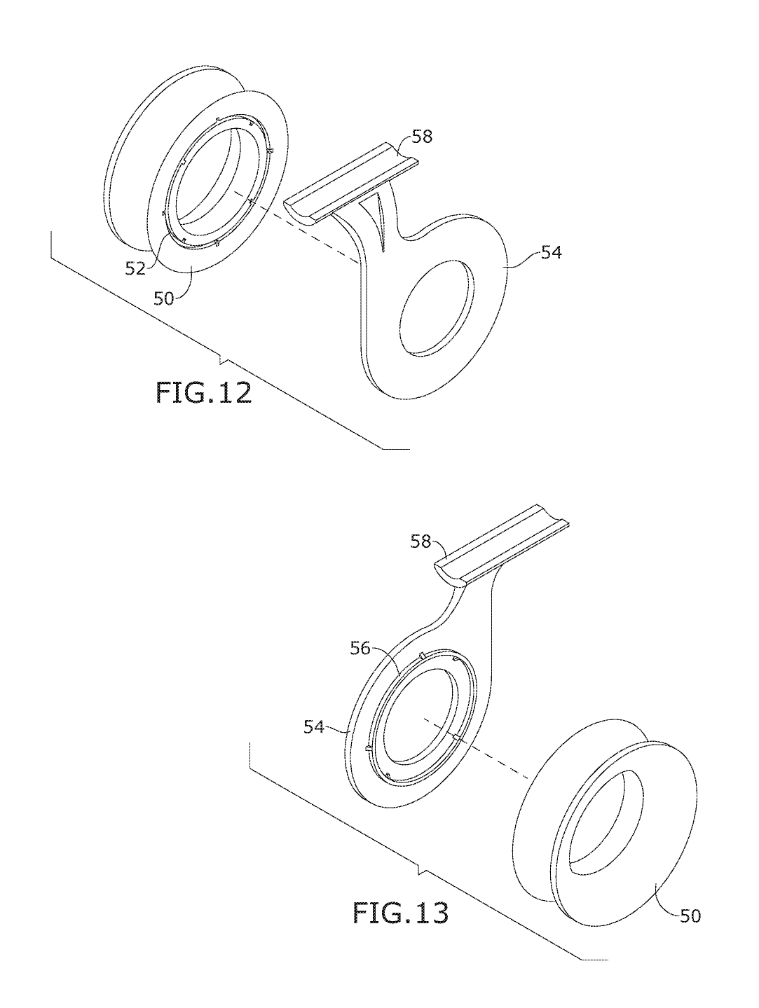

Referring to FIGS. 11 and 12, a fly fishing training aid includes a base 50 and a connector 58. The base 50 includes a spool having a circular shape. The base 50 further includes a first sidewall 54 joined to and extending from a first side edge of the spool and a second sidewall joined to and extending from a second side edge of the spool. A looped channel is defined in between the first sidewall, the spool and the second sidewall. The first sidewall, the spool, and the second sidewall are fixed together. The connector 58 is joined to and extends from the first sidewall 54. The first sidewall 54 is releasably attached to the first side edge of the spool by a male snap ring 56 and a female snap ring 52. The male snap ring 56 may protrude from an inner surface of the first sidewall 54. The female snap ring 52 may be formed on the outer edge of the spool.

The present invention may be made of plastic, fiberglass, wood, rubber, metal, or a combination thereof. It may also be cast in metal, fiberglass, rubber, and plastic. The present invention may also be made by injection molding and/or 3D printing.

It should be understood, of course, that the foregoing relates to exemplary embodiments of the invention and that modifications may be made without departing from the spirit and scope of the invention as set forth in the following claims.

What is claimed is:

1. A fly fishing training aid comprising:
a base comprising a spool comprising a cylinder shape, a first sidewall joined to and extending from a first side edge of the spool, and a second sidewall joined to and extending from a second side edge of the spool, wherein a looped channel is defined in between the first sidewall, the spool and the second sidewall, and the first sidewall, the spool, and the second sidewall are fixed together; and
a connector joined to and extending from the base, wherein the connector is configured to secure the base to a fishing pole.

2. The fly fishing training aid of claim 1, wherein a cross-section of the base comprises a U-shape.

3. The fly fishing training aid of claim 1, wherein the connector comprising an attachment foot.

4. The fly fishing training aid of claim 3, wherein the attachment foot is extending from one of the first sidewall and the second sidewall.

5. The fly fishing training aid of claim 3, wherein the attachment foot comprises an elongated half pipe shape.

6. The fly fishing training aid of claim 1, wherein the connector is a butt cap attachment.

7. The fly fishing training aid of claim 6, wherein the butt cap attachment comprises a tube having an open end and a closed end.

8. The fly fishing training aid claim 1, wherein the base further comprises a plurality of slots each running from the first sidewall, across the spool and to the second sidewall, wherein the plurality of slots are spaced apart circumferentially about the base.

9. The fly fishing training aid of claim 1, wherein the base is formed of a plurality of adjoined wires.

10. The fly fishing training aid of claim 1, wherein the connector is joined to and extending from the first sidewall, and the first sidewall is releasably attached to the first side edge of the spool by a male snap ring and a female snap ring.
